(19) United States
(12) Patent Application Publication
(10) Pub. No.: US 2010/0270878 A1
(43) Pub. Date: Oct. 28, 2010

(54) Vibration Motor

(76) Inventor: Young Il Park, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/743,747

(22) PCT Filed: Nov. 19, 2008
(86) PCT No.: PCT/KR08/06817

§ 371 Date: May 19, 2010

(30) Foreign Application Priority Data
Nov. 19, 2007 (KR) 10-2007-0117773

(51) Int. Cl. H02K 3/44; H02K 7/075

(52) U.S. Cl. 310/71; 310/81

(57) ABSTRACT

A vibration motor according to embodiments includes: a case defining a through-hole; a shaft supported by the case; a rotor rotatably coupled to the shaft; a stator disposed around the shaft to face the rotor; a brush electrically connecting the rotor; a first substrate electrically connected to the brush and disposed within the case; a second substrate electrically connected to the first substrate and disposed outside the case; and a connecting terminal and an anti-corrosion agent disposed within the through-hole, the connecting terminal electrically connecting the first substrate and the second substrate, and the anti-corrosion agent partially formed on the connecting terminal.

### TECHNICAL FIELD

The present invention relates to a vibration motor.

### BACKGROUND ART

Electronic devices such as portable communication devices have a built-in vibration motor that generates vibrations for received signals or input signals.

A vibration motor has an eccentric rotor having a coil, and a a stator provided with a magnet facing the rotor, installed within a case. Thus, when current is supplied to the coil, the interaction between the coil and the magnet causes the rotor to rotate and generate vibrations.

In accordance with miniaturization and slimming of electronic devices, vibration motors are being miniaturized and slimmed.

### DISCLOSURE OF INVENTION

### Technical Problem

Embodiment provide a vibration motor.

Embodiments also provide a slimmed vibration motor.

Embodiments further provide a vibration motor with increased torque without an increase in thickness.

### Technical Solution

In one embodiment, a vibration motor includes: a case defining a through-hole; a shaft supported by the case; a rotor rotatably coupled to the shaft; a stator disposed around the shaft to face the rotor; a brush electrically connecting the rotor; a first substrate electrically connected to the brush and disposed within the case; a second substrate electrically connected to the first substrate and disposed outside the case; and a connecting terminal and an anti-corrosion agent disposed within the through-hole, the connecting terminal electrically connecting the first substrate and the second substrate, and the anti-corrosion agent partially formed on the connecting terminal.

In another embodiment, a vibration motor includes: a case including an upper case and a lower case defining a through-hole; a shaft supported by the case; a rotor rotatably coupled to the shaft; a stator disposed on the lower case to face the rotor; a brush electrically connecting the rotor; a first substrate electrically connected to the brush and installed on the lower case; a contacting terminal electrically connected to the first substrate and disposed within the through-hole; a connecting terminal electrically connected to the contacting terminal and disposed within the through-hole; and a second substrate electrically connected to the connecting terminal and installed under the lower case.

### Advantageous Effects

Embodiments can provide a vibration motor.

Embodiments can also provide a slimmed vibration motor.

Embodiments can further provide a vibration motor with increased torque without an increase in thickness.

### BRIEF DESCRIPTION OF DRAWINGS

FIG. 1 is a sectional view of a vibration motor according to embodiments.

FIG. 2 is a diagram for describing a vibration motor according to embodiments.

### MODE FOR THE INVENTION

Below, a vibration motor according to embodiments of the present invention will be described in detail, with reference to the attached drawings.

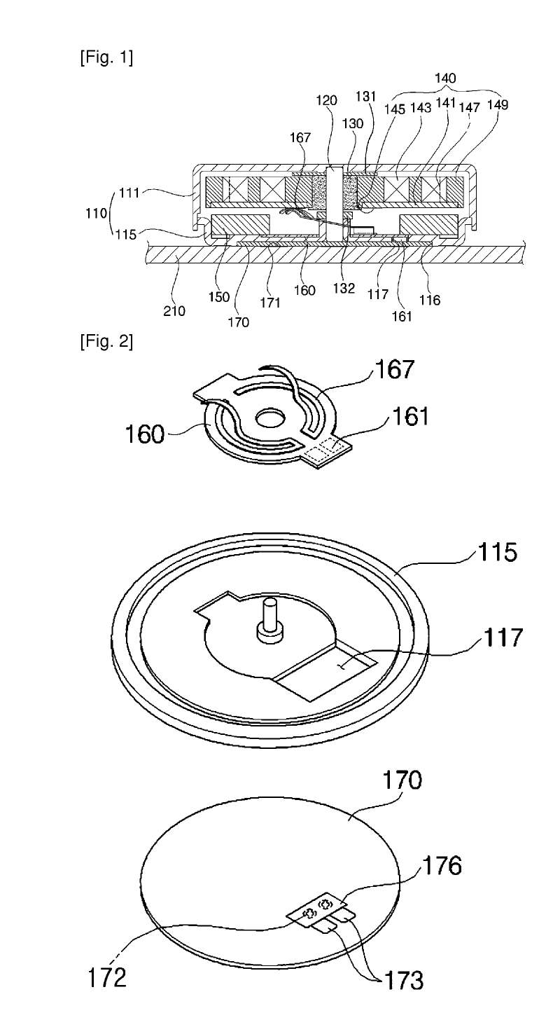

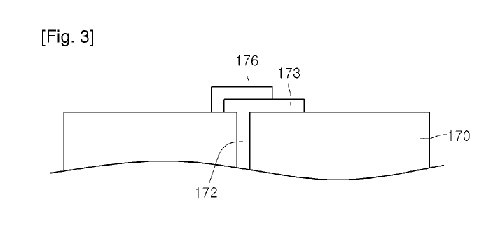

FIG. 1 is a sectional view of a vibration motor according to embodiments, FIG. 2 is a diagram for describing a vibration motor according to embodiments of the present invention, in which a first substrate, a lower case, and a second substrate are described, and FIG. 3 is a diagram for describing a connecting terminal formed on a second substrate in a vibration motor according to embodiments of the present invention.

Referring to FIGS. 1 to 3, a case 110 including an upper case 111 and a lower case 115 is provided. The case 110 defines a space in which a rotor 140 and stator 150 are installed, and the upper case is disposed above the lower case 115 and coupled with the lower case 115.

The upper case 111 and lower case 115 may be formed of the same material or formed of different materials—for example, the upper case 111 may be formed of a metal material, and the lower case 115 may be formed of a printed circuit board (PCB). However, present embodiments describe the upper case 111 and the lower case 115 as both formed of a metal material.

A shaft 120 is installed inside the case 110, and a bearing 130 is installed inserted on the shaft 120. The shaft 120 is supported at one end by the upper case 111 and at the other end by the lower case 115. For example, the shaft 120 may be welded and fixed to the upper case 111 and/or the lower case 115.

A first washer 131 may be disposed between the bearing 130 and the upper case 111, and a second washer 132 may be disposed between the bearing 130 and the lower case 115.

A first substrate 160 in a shape enclosing the shaft 120 is disposed at the central portion on the upper surface of the lower case 115, and a second substrate 170 is electrically connected to the first substrate 160 and coupled to the undersurface of the lower case 115.

A contacting terminal 161 electrically connected to the second substrate 170 is formed on the first substrate 160, and the contacting terminal 161 is electrically connected to the second substrate 170 through a through-hole 117 defined in the lower case 115.

An enclosing recess 116 is defined in the undersurface of the lower case 115, in which the second substrate 170 is inserted and enclosed. Because the second substrate 170 is inserted and installed in the enclosing recess 116, the thickness of the vibration motor can be reduced by the thickness of the second substrate 170. Thus, a slim vibration motor can be provided.

The undersurface of the lower case 115 of the outside of the enclosing recess 116 may be fixed to a product substrate 210 of a product in which the vibration motor is installed, through automated reflow processing.

An annular stator 150 is installed on the upper portion of the lower case 115. The stator 150 may be formed with a magnet.

The rotor 140 that is rotated to interact with the stator 150 is coupled to the bearing 130. When the rotor 140 rotates, its eccentricity generates vibrations.

The rotor 140 includes a rotor substrate 141, a coil 143, a weight 147, and a supporting member 149.

The rotor substrate 141 includes a commutator 145 formed on its undersurface, and the coil 143 that is electrically connected with the rotor substrate 141 is installed on the upper surface of the rotor substrate 141.

The weight 147 may be formed of a metal material, and generates vibrational force through eccentricity.

The supporting member 149, through injection of a synthetic resin material, integrates and supports the rotor substrate 141, the coil 143, and the weight 147, and is coupled to the bearing 130.

A brush 167 is installed atop the first substrate 160, and the brush 167 is electrically connected through elastic contact with the commutator 145 to supply power to the coil 143.

Accordingly, power provided from the product substrate 210 is supplied to the coil 143 through the second substrate 170, the contacting terminal 161, the first substrate 160, the brush 167, and the rotor substrate 141 including the commutator 145.

When power is supplied to the coil 143, mutual interaction between the rotor 140 and the stator 150 rotates the stator 140.

A power terminal 171 electrically connected to the product substrate 210 is formed on the undersurface of the second substrate 170, and a connecting terminal 173 electrically connected to contacting terminal 161 is formed on the upper surface of the second substrate 170.

The connecting terminal 173 is electrically connected to a via 172 passing through the second substrate 170, and disposed on the upper surface of the second substrate 170.

The via 172 and connecting terminal 173 may be formed of copper (Cu) or a metal alloy including copper.

To prevent corrosion, an anti-corrosion agent 176 is formed on a portion of the connecting terminal 173. The anti-corrosion agent 176 may be formed of ink and have insulating properties.

The portion of the connecting terminal 173 without the anti-corrosion agent 176 formed thereon is electrically connected to the contacting terminal 161. For example, the connecting terminal 173 and the contacting terminal 161 may be attached through soldering, and an electroplating layer (not shown) may be formed on a portion of the connecting terminal 173 not having the anti-corrosion agent 176 formed thereon in order to improve soldering characteristics. The electroplating layer may be formed of gold, for example.

The anti-corrosion agent 176 is formed on a top portion of the connecting terminal 173 and on top of the second substrate 170 proximate to the connecting terminal 173, and the space taken up by the anti-corrosion agent 176 and the connecting terminal 173 is smaller than the through-hole 117 of the lower case 115.

Also, the anti-corrosion agent 176 and the connecting terminal 173 are formed on the second substrate 170 corresponding to the through-hole 117 of the lower case 115.

Thus, when the lower case 115 and the second substrate 170 are coupled, the anti-corrosion agent 176 and the connecting terminal 173 are disposed inside the through-hole 117 of the lower case 115.

As a result, the depth of the enclosing recess 116 may be formed shallower by the thickness of the connecting terminal 173 and the anti-corrosion agent 176.

For example, the connecting terminal 173 may be formed with a thickness of 0.02-0.05 mm, and the anti-corrosion agent 176 may be formed with a thickness of 0.03-0.05 mm. Therefore, when the connecting terminal 173 and the anti-corrosion agent 176 are disposed within the through-hole 117 of the lower case 115, thickness can be reduced by 0.05-0.1 mm.

Accordingly, the vibration motor can be formed to be slimmer by the thickness of the connecting terminal 173 and the anti-corrosion agent 176, or the space between the lower case 115 and the upper case 111 can be enlarged to increase the thickness taken up by the rotor 140 or stator 150 and increase the torque of the vibration motor.

While the present invention has been described above with reference to an embodiment of the present invention, it will be apparent to those having ordinary skill in the art to which the present invention belongs that alterations and modifications which do not depart from the technical spirit and scope of the present invention are included in the present invention.

### INDUSTRIAL APPLICABILITY

A vibration motor according to embodiments can be applied to various electronic devices that require vibration.

1. A vibration motor comprising:
a case defining a through-hole;
a shaft supported by the case;
a rotor rotatably coupled to the shaft;
a stator disposed around the shaft to face the rotor;
a brush electrically connecting the rotor;
a first substrate electrically connected to the brush and disposed within the case;
a second substrate electrically connected to the first substrate and disposed outside the case; and
a connecting terminal and an anti-corrosion agent disposed within the through-hole, the connecting terminal electrically connecting the first substrate and the second substrate, and the anti-corrosion agent partially formed on the connecting terminal.

2. The vibration motor according to claim 1, wherein the first substrate comprises a contacting terminal formed thereon and electrically connected to the connecting terminal.

3. The vibration motor according to claim 1, wherein the connecting terminal comprises an electroplating layer formed on a portion thereof that does not have the anti-corrosion agent formed thereon.

4. The vibration motor according to claim 1, wherein the anti-corrosion agent is formed of ink.

5. The vibration motor according to claim 1, wherein the anti-corrosion agent comprises insulating properties.

6. The vibration motor according to claim 1, wherein the case defines an enclosing recess in which the second substrate is inserted and installed.

7. The vibration motor according to claim 1, wherein the second substrate comprises a power terminal formed thereon, the power terminal electrically connected to the connecting terminal through a via passing through the second substrate.

8. The vibration motor according to claim 1, wherein the connecting terminal and the anti-corrosion agent consume a space that is smaller than a space of the through-hole.

9. A vibration motor comprising:
a case comprising an upper case and a lower case defining a through-hole;
a shaft supported by the case;
a rotor rotatably coupled to the shaft;
a stator disposed on the lower case to face the rotor;
a brush electrically connecting the rotor;
a first substrate electrically connected to the brush and installed on the lower case;
a contacting terminal electrically connected to the first substrate and disposed within the through-hole;
a connecting terminal electrically connected to the contacting terminal and disposed within the through-hole; and
a second substrate electrically connected to the connecting terminal and installed under the lower case.

10. The vibration motor according to claim 9, wherein the connecting terminal and the second substrate comprise an anti-corrosion agent partially formed thereon, the anti-corrosion agent disposed within the through-hole.

11. The vibration motor according to claim 9, wherein the connecting terminal comprises an electroplating layer partially formed thereon.

12. The vibration motor according to claim 10, wherein the anti-corrosion agent is formed of ink.

13. The vibration motor according to claim 10, wherein the anti-corrosion agent comprises insulating properties.

14. The vibration motor according to claim 9, wherein the lower case comprises an enclosing recess defined in an undersurface thereof, and the second substrate is inserted and installed in the enclosing recess.

15. The vibration motor according to claim 9, wherein the second substrate comprises a power terminal formed on an undersurface thereof, the power terminal electrically connected to the connecting terminal through a via passing through the second terminal.

16. The vibration motor according to claim 10, wherein the connecting terminal and the anti-corrosion agent consume a space that is smaller than a space of the through-hole.
